(19) United States
(12) Patent Application Publication
(10) Pub. No.: US 2003/0057879 A1
(43) Pub. Date: Mar. 27, 2003

(54) Lighting electronic controller

(76) Inventor: Carmine Joseph Capriglione, Dumfries, VA (US)

Correspondence Address: CARMINE JOSEPH CAPRIGLIONE, 409 LINTON COURT, DUMFRIES, VA, 22026, US

(21) Appl. No.: 09/934,433

(22) Filed: Aug. 22, 2001

(51) Int. Cl. H05B 37/02

(52) U.S. Cl. 315/291; 315/209 R

(57) ABSTRACT

A lighting electronic controller comprised of digital control and interface circuits, a master clock timer, a number of slave timers staged in a specific configuration with time delays individually selected to accomplish a specific logical sequence of timing, dimmer circuits, power supply, and support circuits all functioning together in a unique way to automatically control an external device such as a lighting fixture. The controller can switch on an external device such as a house lamp at some predetermined time and automatically increase or decrease the light intensity in gradual stages. The illumination of each stage, the background illumination and the final maximum illumination can all be set using this controller to give a unique lighting effect. The time of day when the controller turns on is determined by the user. The total repetitive time during which the lighting is gradually increased or decreased through the various stages can also be set by the user. The number of stages can vary and is designed for the desired overall effect. Although the brightness levels and time durations can be adjustable, they can also come fixed and pre-selected. One use is to automatically simulate the gradual illumination of the sunrise, as in a dark room or adjacent room and thereby assist a person in rising very early before sunrise or during a time of year when the sun does not rise as early. The controller can also be used to decrease the overall lighting such as at bedtime, and this will gradually change the mood in the evening as bedtime approaches. This is more than a light connected to a timer. The controller is a multiple stage sequential light level control device that repeats its operation and which can have as many stages of lighting control as desired.

This invention relates to a lighting electronic controller. More particularly, the invention relates to a unique lighting electronic controller that uses multiple control stages, interfaces, and timing circuits that are calculated to trigger a sequence of light switching events to produce an overall lighting effect. A master clock timer and a number of slave timers are configured in a specific series of stages such that their individual time delays work in a logical sequence to produce the desired final lighting control effect. Calculations were made and active and passive electronic components were selected to produce the desired overall automatic control effect. The controller layout is a logical configuration of the various functioning sections, which includes circuits for the higher voltage house current such as the typical U.S. system for 120 volts, the lower voltage circuits for the digital control logic and interface circuits comprised of switching transistors and relays, as well as the dimmer circuits. The controller works in a continuous automatic repetitive operation.

### FIELD OF THE INVENTION

The present invention relates to an electronic controller to control lighting fixtures to bring about a unique lighting result. One or more lighting fixtures such as an ordinary house lamp or night-light can be plugged into the output receptacle of this controller. The controller is then plugged into an ordinary power outlet through the line cord and plug at the input of the controller. One main use of this controller is to simulate the gradual illumination of the sunrise, as in a dark room or adjacent room and thereby assist a person in rising very early before sunrise. The controller can also be used to decrease the overall level of lighting in its various stages, to produce mood lighting in the evening and at bedtime. The controller can work with the standard U.S. system of 120 volts. The same principal will work for other voltage systems such as those utilized in Europe and around the world, with the appropriate adjustment for voltage and receptacle differences. The controller can also be hard wired into a lighting circuit to accomplish the same function. The multiple stages and sequence operation make this controller unique.

### DESCRIPTION OF THE INVENTION

The present invention comprises a line cord with plug to be plugged into the ordinary household power outlet. This supplies ordinary power to the electronic controller. In the U.S. system this will be 120 volts alternating current usually from a 20 amp power source. The circuits of the lighting electronic controller are safely housed in a device enclosure. Settings are controlled through buttons and knobs from the outside of the housing. Output receptacles are also provided on the housing into which the external lighting fixtures can be plugged. The invention focuses on the capability, operation and function of the lighting controller and does not limit the device housing to a specific geometry.

The present invention uses available power to operate its own circuitry as well as to control that very power, which is then used by the lighting fixtures. The clock and timing portion of the controller will automatically initiate the device at the predetermined time of day. Then the controller portion of the device will gradually and automatically supply power to the external lighting fixtures that are connected to the controller receptacle. It is the gradual step by step increase in the output power and voltage that increases the intensity of the lighting fixtures connected to the controller. The time duration, the individual lighting levels, and the final intensity of the lighting are also controlled. The present invention will automatically increase or decrease the lighting in a room in a gradual controlled way that is selected by the user. One main benefit is to help a person to rise early in the morning and make it more pleasant to adjust, especially when it is dark outside. When one or more lamps, or even a night light, is connected to this controller the effect will be to simulate the gradual illumination of the sunrise in multiple stages of lighting. Gradual adjustment to the lighting will make rising more pleasant. The multiple lighting levels and the automatic repeating sequence makes this controller unique.

The foregoing objects and advantages of the present invention will become more apparent from a consideration of the following detailed description of a preferred embodiment, with reference to the accompanying drawings showing the invention by way of a non-limiting example thereof, in which:

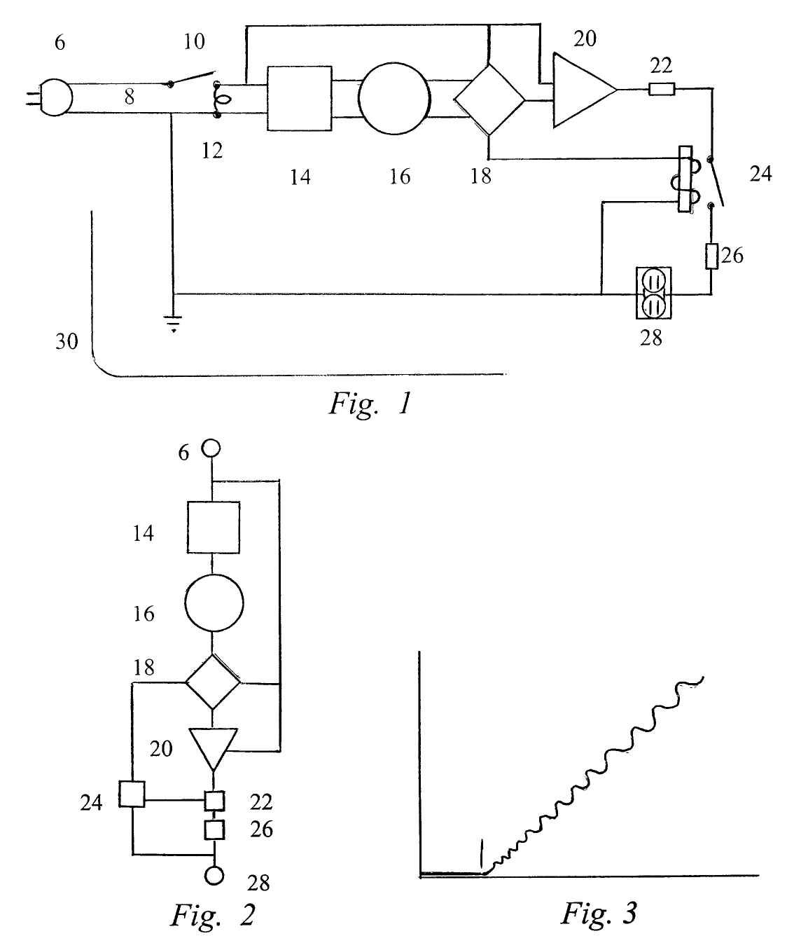

FIG. 1 is a circuit diagram of the lighting electronic controller which shows its operation and the functional interconnection of the various stages and components.

FIG. 2 is a flow diagram that shows the logic flow connection of the main components from input to output.

FIG. 3 is a graph showing a representative output signal for an increasing lighting operation through its multiple stages over a specific time.

### DETAILED DESCRIPTION OF PREFERRED EMBODIMENT

Referring to the accompanying drawings, the present invention is seen in FIG. 1 to comprise an input power plug designated 6 and input line cord 8 to supply input voltage to the controller. This energizes a power supply 14 through on-off switch 10 and master clock 12. The power supply 14 provides lower voltage DC power for the digital circuits and other components of the controller. The master clock 12 can be set for a specific time of day to turn the controller on, and it will also turn the controller off if the user chooses. This initiates the slave timers 18 of the multiple stages, three stages are shown here. The unique feature of this controller is the way the multiple stages perform in a staggered time delay sequence. Calculations were made to select the correct timing components such that each of the stages work together as desired. The number of slave timers and multiple stages can vary, such as three stages for a typical controller to more for an elaborate controller. These timer stages 18 work together to trigger the switching transistors 20, and this is done in the exact sequence and timing calculated. There is one transistor for each stage, along with the current limiting resistors all designated as 22. The switching transistors drive the interface relays 24 with the low voltage signals. The interface relays 24 control the higher voltages, and connects the individual dimmers 26 to the output receptacle 28. The input AC power energizes the dimmer circuits through the relay switches. There is one additional dimmer to provide the background lighting. In order to pre-select the individual lighting levels at each of the stages, push button switches 16 are provided. These switches will temporarily bypass the relay terminals when depressed. There is one push button switch for each stage. The user can depress each push button switch in turn and adjust the lighting level for that stage. So, when a timing circuit automatically allows a particular stage to activate, that pre-selected lighting level is what will come on.

There is an overlap in the sequence such that all stages activate before the first stage reverts back to its initial condition. This operation is important to the proper function of the controller. In addition, the slave timers 18 are connected in a unique way so that they actually inhibit rather that turn on the next stage. Therefore, when a particular timing stage is on, the switching transistor is on and current flows to energize the relay which has its terminals wired to be normally closed, and this has the effect of turning the dimmer circuit off thus inhibiting that lighting circuit. Conversely, when the timing stage is off, the direct opposite of this condition occurs and the dimmer is energized and that lighting circuit comes on. The advantage of this is that proper operation of the overall lighting controller occurs at power initiation, when the slave timers activate and turn on. This solves the initiation problem associated with timers and control circuits.

The background light level comes on and each sequential lighting stage only comes on after the predetermined time delay, that is, when the slave timer turns off. After each of the timing stages has made its first switch, the cycle will repeat as each timer reverts back to its initial condition. This continues to repeat unless the master timer has a shut off time selected by the user, in which case the entire controller will then shut off.

FIG. 2 is a logical flow diagram from input 6 to output 28. This serves to show the logic signal flow as the description of the invention states. The AC input power at 6 is timed, controlled and delivered to the output at 28. Rather than plugging a lamp or other lighting fixture directly into a power outlet, it is plugged into this controller. The controller is then plugged into the power source. Therefore, the lighting controller comes between the power source and the lighting fixture and functions as described. Timing, duration and the lighting intensity are all selected using this controller. The light does not have to come on at full intensity. It can come on at the dim background illumination and automatically increase in stages, or decrease from brighter to lower when reverse settings are selected.

FIG. 3 shows a typical output voltage over time for an increase in lighting. The dim background lighting starts at the left lower curve and increases in stages with each higher curve. This is designed to provide the unique overall lighting effect. It can be thought of as a visual snooze alarm. The decreasing curve is similar, higher to lower.

While this invention has been described as having certain preferred features and embodiments, it will be apparent that it is capable of still further variation and modification without departing from the spirit of the invention, and this application is intended to cover any and all variations, modifications and adaptations as may fall within the spirit of the invention and the scope of the appended claims. For example, a three-way light bulb can be used for the light levels instead of dimmers, or the master timer can be by-passed or even eliminated and the user can just turn the controller on to perform its multiple stage function.

I claim:

1. A lighting electronic controller that has the capability to switch on and off and to automatically control an external device such as a lighting fixture in a unique sequential repetitive operation to increase or decrease the light intensity in a number of gradual stages over a period of time to bring about a specific desired lighting effect.

2. A lighting electronic controller as in claim 1 and wherein said controller can be adjusted to select the individual light level intensity for each stage of illumination as the device operates in sequence to gradually increase or decrease the overall lighting effect.

3. A lighting electronic controller as in claim 2 and wherein said controller can be adjusted to determine the overall time during which the lighting is gradually increased or decreased in the repetitive sequences and also the time durations of those individual stages of lighting.

4. A lighting electronic controller as in claim 3 and wherein said controller can be adjusted to determine the time of day when the device will automatically turn on and start the lighting sequence control function and also turn off if so desired.
